(19) United States
(12) Patent Application Publication
(10) Pub. No.: US 2023/0100131 A1
(43) Pub. Date: Mar. 30, 2023

(54) INTERNAL-COMBUSTION-ENGINE CONTROL APPARATUS

(71) Applicant: Mitsubishi Electric Corporation, Tokyo (JP)

(72) Inventor: Kimihiko TANAYA, Tokyo (JP)

(73) Assignee: Mitsubishi Electric Corporation, Tokyo (JP)

(21) Appl. No.: 17/878,546

(22) Filed: Aug. 1, 2022

(30) Foreign Application Priority Data
Sep. 29, 2021 (JP) 2021-158685

(51) Int. Cl. F02P 3/04; F02P 13/00

(52) U.S. Cl. CPC F02P 3/0407; F02P 13/00

(57) ABSTRACT

An internal-combustion-engine control apparatus according to the present disclosure controls an internal combustion engine having
a main combustion chamber,
a subsidiary combustion chamber,
an ignition plug that is disposed in the subsidiary combustion chamber,
an ignition coil connected with the ignition plug, and
an orifice for connecting the subsidiary combustion chamber with the main combustion chamber and for injecting combustion gas in the subsidiary combustion chamber into the main combustion chamber; the internal-combustion-engine ignition apparatus includes
an ignition control unit that controls energization of the ignition coil so that an ignition discharge for igniting a fuel-air mixture in the subsidiary combustion chamber is produced across the ignition plug, and
a pressure-boosting control unit that controls energization of the ignition coil so that a pressure-boosting discharge for increasing a pressure of combustion gas in the subsidiary combustion chamber is produced across the ignition plug.

### TECHNICAL FIELD

The present disclosure relates to an internal-combustion-engine control apparatus.

### BACKGROUND ART

As countermeasures for global warming that has been problematized in recent years, world-wide approach to reduce greenhouse effect gas has started. Because this approach is required also in the automobile industry, development for improving the efficiency of an internal combustion engine is being promoted.

Among internal combustion engines, there exists an internal combustion engine provided with a subsidiary combustion chamber having an orifice at the front end of an ignition plug. A fuel-air mixture is ignited in the subsidiary combustion chamber and then combustion flame is injected through the orifice into a main combustion chamber. The internal combustion engine in which a fuel-air mixture in the main combustion chamber is ignited with the injected combustion flame is referred to as a subsidiary-chamber-type internal combustion engine (for example, Patent Document 1). This method raises the speed and continuity of flame propagation for the fuel-air mixture in the main combustion chamber. Accordingly, because the combustion period can be shortened even by use of a lean fuel-air mixture, stable combustion can be maintained. Accordingly, because the thermal efficiency can largely be raised through lean combustion, the method has been drawing attention, as a method in which the exhaust amount of greenhouse effect gas can largely be reduced.

### CITATION LIST

### Patent Literature

Patent Document 1: Japanese Patent Application Laid-Open No. 2017-103179

The subsidiary combustion chamber of a subsidiary-chamber-type internal combustion engine is characterized by being connected with the main combustion chamber though an orifice. Design related to an orifice exerts a major influence on the performance of the subsidiary-chamber-type internal combustion engine. When the diameter of the orifice becomes large, the scavenging performance of the subsidiary combustion chamber is raised and hence the thermal loss in the orifice decreases. However, when the diameter of the orifice becomes large, injection power of a combustion flame from the subsidiary combustion chamber decreases and hence the speed and continuity of flame propagation in the main combustion chamber is deteriorated. As a result, the combustion stability, to a lean fuel-air mixture, of the subsidiary-chamber-type internal combustion engine is deteriorated.

When the diameter of the orifice becomes small, injection power of a combustion flame from the subsidiary combustion chamber increases and hence the speed and continuity of flame propagation in the main combustion chamber is raised. As a result, the combustion stability, to a lean fuel-air mixture, of the subsidiary-chamber-type internal combustion engine is improved. However, when the diameter of the orifice becomes small, the scavenging performance of the subsidiary combustion chamber is deteriorated and hence the thermal loss in the orifice increases. In a subsidiary-chamber-type internal combustion engine, the design in which these effects balance with each other is very important.

It poses a problem that it may be difficult to realize the design in which the combustion stability to a lean fuel-air mixture, the scavenging performance, and the thermal loss balance with one another. Patent Document 1 discloses a technology for specifying the relationship between the volume of a subsidiary combustion chamber and the cross-sectional area of an orifice so as to solve this problem. However, due to a temporal condition change caused by a change in the operational condition of an internal combustion engine, carbon deposits, exhaustion and deterioration of a metal member, or the like, the condition in the subsidiary combustion chamber changes from moment to moment. In the case where such changes are uniformly coped with by the specification of the relationship between the volume of the subsidiary combustion chamber and the cross-sectional area of the orifice, there occurs a limit.

### SUMMARY OF INVENTION

The present disclosure is to disclose a technology for solving the foregoing problems. The objective thereof is to provide an internal-combustion-engine control apparatus that provides combustion-flame injection power capable of securing the combustion stability to a lean fuel-air mixture, while maintaining the diameter of an orifice having an excellent scavenging performance and a suppressed thermal loss in a subsidiary-chamber-type internal combustion engine.

### Solution to Problem

An internal-combustion-engine control apparatus according to the present disclosure controls an internal combustion engine having

a main combustion chamber,

a subsidiary combustion chamber,

an ignition plug that is disposed in the subsidiary combustion chamber,

an ignition coil connected with the ignition plug, and

an orifice for connecting the subsidiary combustion chamber with the main combustion chamber and for injecting combustion gas in the subsidiary combustion chamber into the main combustion chamber so as to ignite a fuel-air mixture in the main combustion chamber; the internal-combustion-engine control apparatus includes

an ignition control unit that controls energization of the ignition coil so that an ignition discharge for igniting a fuel-air mixture in the subsidiary combustion chamber is produced across the ignition plug, and

a pressure-boosting control unit that controls energization of the ignition coil so that a pressure-boosting discharge for increasing a pressure of combustion gas in the subsidiary combustion chamber is produced across the ignition plug.

### Advantage of Invention

An internal-combustion-engine control apparatus according to the present disclosure can provide combustion-flame injection power capable of securing the combustion stability to a lean fuel-air mixture, while maintaining the diameter of an orifice having an excellent scavenging performance and a suppressed thermal loss in a subsidiary-chamber-type internal combustion engine.

### BRIEF DESCRIPTION OF DRAWINGS

FIG. 1 is a schematic configuration diagram of an internal combustion engine according to Embodiment 1;

FIG. 2 is a hardware configuration diagram of an internal-combustion-engine control apparatus according to Embodiment 1;

FIG. 3 is a diagram for explaining operational sections of the internal-combustion-engine control apparatus according to Embodiment 1;

FIG. 4 is a timing chart representing the operation of the internal-combustion-engine control apparatus according to Embodiment 1;

FIG. 5 is a table representing resonance modes of combustion gas in the internal combustion engine according to Embodiment 1;

FIG. 6 is a first flowchart representing processing in the internal-combustion-engine control apparatus according to Embodiment 1;

FIG. 7 is a second flowchart representing processing in the internal-combustion-engine control apparatus according to Embodiment 1;

FIG. 8 is a timing chart representing the operation of an internal-combustion-engine control apparatus according to Embodiment 2;

FIG. 9 is a timing chart representing the operation of an internal-combustion-engine control apparatus according to Embodiment 3; and

FIG. 10 is a timing chart representing the operation of an internal-combustion-engine control apparatus according to Embodiment 4.

### DESCRIPTION OF EMBODIMENTS

Hereinafter, a control apparatus 110 of an internal combustion engine 100 according to the present disclosure will be explained with reference to the drawings. In the respective drawings, the same reference characters denote the same or similar constituent elements. In the present embodiment, as the internal combustion engine 100, a spark-ignition reciprocal internal combustion engine (reciprocal engine) is assumed.

### 1. Embodiment 1

### <Configuration of Internal Combustion Engine>

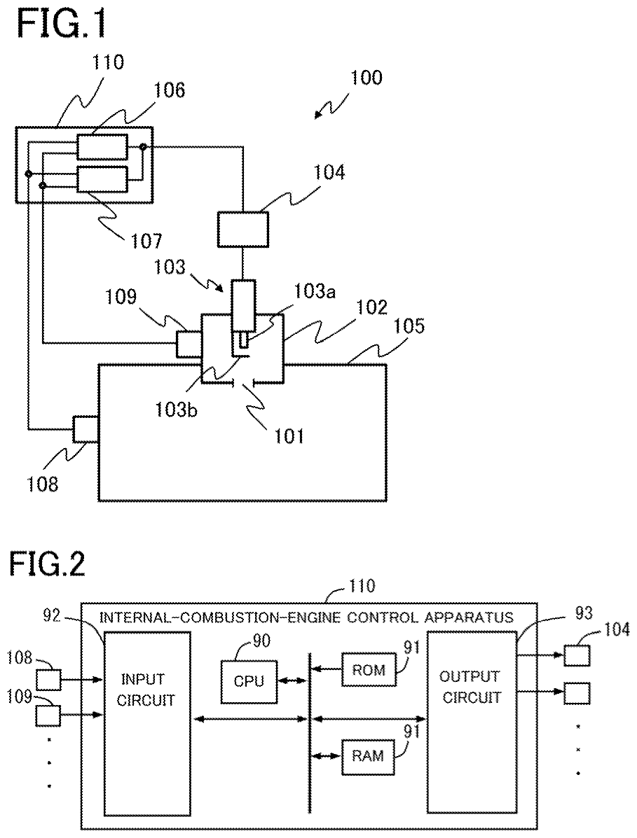

FIG. 1 is a configuration diagram of an internal combustion engine 100 according to Embodiment 1 and is a simplified conceptual diagram. The internal combustion engine 100 has a main combustion chamber 105, a subsidiary combustion chamber 102, and an orifice (communication portion) 101 that makes the main combustion chamber 105 and the subsidiary combustion chamber 102 communicate with each other. An ignition plug 103 having an electrode 103a and a grounding electrode 103b is disposed in the subsidiary combustion chamber 102.

An ignition coil 104 supplies a high voltage to the ignition plug 103, so that a spark discharge is formed in a discharging gap between the electrode 103a and the grounding electrode 103b of the ignition plug 103. It may be allowed that the grounding electrode 103b is connected with a minus terminal of a battery by way of the subsidiary combustion chamber 102. It may also be allowed that the grounding electrode 103b is connected with the minus terminal of the battery by way of the ignition coil 104.

The ignition coil 104 has a primary coil connected with a power source, a secondary coil magnetically connected with the primary coil, and a power transistor for operating energization or de-energization of the primary coil. The secondary coil is connected with the ignition plug 103. The ignition coil 104 is connected with the control apparatus 110 of the internal combustion engine 100 (hereinafter, referred to simply as a control apparatus 110); in response to a control signal from the control apparatus 110, the power transistor turns on or off so as to perform energization or de-energization of the primary coil. Energy accumulated due to energization of the primary coil makes the secondary coil generate a high voltage when the primary coil is de-energized, so that a spark discharge is formed across the discharging gap of the ignition plug 103.

In FIG. 1, the descriptions for the power transistor, the primary coil, and the secondary coil of the ignition coil 104 are omitted. In this example, there has been explained the case where the power transistor for energizing or de-energizing the primary coil is incorporated in the ignition coil 104; however, the power transistor may be incorporated in the control apparatus 110.

An intake port and an intake valve linked with an intake pipe and an exhaust port linked with an exhaust pipe are provided in the main combustion chamber 105. Moreover, a piston that is connected with a rod inked with a crankshaft and produces an output through reciprocal motion is provided in the main combustion chamber 105. In FIG. 1, the descriptions therefor are omitted.

Based on information items obtained from various kinds of switches, various kinds of sensors, and the like, the control apparatus 110 drives the ignition coil 104, an injector (fuel injector), various kinds of actuators, and the like so as to control the internal combustion engine 100. An ignition control unit 106 and a pressure-boosting control unit 107 are provided in the control apparatus 110 so as to generate a control signal for the ignition coil. The ignition control unit 106 and the pressure-boosting control unit 107 control the ignition coil 104 so as to make the discharging gap of the ignition plug 103 produce a spark discharge.

The ignition coil 104 controlled by the ignition control unit 106 operates; then, a spark discharge is produced across the discharging gap of the ignition plug 103 in the subsidiary combustion chamber 102. This spark discharge will be referred to as an ignition discharge. A fuel-air mixture inside the subsidiary combustion chamber 102 is ignited through an ignition discharge and hence a combustion flame grows. Moreover, in this process, the ignition coil 104 controlled by the pressure-boosting control unit 107 operates; then, a spark discharge is produced across the discharging gap of the ignition plug 103 in the subsidiary combustion chamber 102. This spark discharge will be referred to as a pressure-boosting discharge. The pressure-boosting discharge facilitates a pressure rise in the combustion gas in the subsidiary combustion chamber 102.

The pressure rise in the combustion gas inside the subsidiary combustion chamber 102 can raise the injection power of the combustion flame to be injected from the orifice 101 to the main combustion chamber 105. As a result, the speed and the continuity of flame propagation in the main combustion chamber is raised. Accordingly, the combustion stability, to a lean fuel-air mixture, of the main combustion chamber 105 is improved. Then, the thermal efficiency of the internal combustion engine 100 is raised and hence it is made possible to reduce the amount of the greenhouse effect gas to be exhausted.

The orifice 101 has at least one communication hole. In the case where two or more communication holes exist, there occur two or more flows of the combustion gas that flows from the subsidiary combustion chamber 102 into the main combustion chamber 105 through the orifice 101; thus, because the multi-point ignitability in the combustion inside the main combustion chamber is raised, the speed and the continuity of flame propagation is enhanced. Accordingly, the combustion stability, to a lean fuel-air mixture, of the main combustion chamber 105 is further improved. Then, the thermal efficiency of the internal combustion engine 100 is raised and hence it is made possible to reduce the amount of the greenhouse effect gas to be exhausted. In many cases, three to eight orifice communication holes are provided.

In FIG. 1, as an example of a sensor provided in the main combustion chamber 105, a crank angle sensor 108 is illustrated; as an example of a sensor provided in the subsidiary combustion chamber 102, a temperature sensor 109 is illustrated. It may be allowed that in addition to these sensors, a cam angle sensor, a coolant temperature sensor, an inner-cylinder pressure sensor, an intake pipe pressure sensor, an intake air amount sensor, an intake-air temperature sensor, and the like are provided.

As the internal combustion engine 100 having the subsidiary combustion chamber 102, there exists one that is called an active type in which an injector is disposed in the subsidiary combustion chamber 102 and fuel is directly injected into the subsidiary combustion chamber 102. In addition, there exists one that is called a passive type in which an injector is disposed not in the subsidiary combustion chamber 102 but in the main combustion chamber 105.

In a passive-type internal combustion engine 100, a fuel-air mixture is formed from a fuel injected into the main combustion chamber 105 and then the fuel-air mixture is introduced into the subsidiary combustion chamber 102 by means of a pressure difference between the respective pressures in the main combustion chamber 105 and the subsidiary combustion chamber 102. Moreover, with regard to the passive-type internal combustion engine 100, there also exists a configuration in which an injector is disposed in an intake pipe for introducing intake air into a main combustion chamber and then a fuel-air mixture is introduced into the main combustion chamber.

The technology disclosed in Embodiment 1 can be applied to any one of the foregoing types. It may be allowed that the control apparatus 110 controls the injector. Hereinafter, there will be explained an example of a passive-type configuration in which an injector is disposed in an intake pipe and a fuel-air mixture is introduced into a main combustion chamber.

FIG. 1 illustrates an example in which the ignition plug 103 is disposed only in the subsidiary combustion chamber 102. However, it may be allowed that the ignition plug is disposed not only in the subsidiary combustion chamber 102 but also in the main combustion chamber 105. In this case, the ignition control unit 106 controls the ignition plug disposed in the subsidiary combustion chamber 102 or both of the ignition plugs arranged in the main combustion chamber 105 and in the subsidiary combustion chamber 102, and the pressure-boosting control unit 107 controls the ignition coil 104 connected with the ignition plug 103 disposed in the subsidiary combustion chamber 102.

### <Hardware Configuration of Control Apparatus>

FIG. 2 is a hardware configuration diagram of the control apparatus 110 according to Embodiment 1. In the present embodiment, the control apparatus 110 is a control apparatus for controlling the internal combustion engine 100. Respective functions of the control apparatus 110 are realized by processing circuits provided in the control apparatus 110. Specifically, the diagnosis control unit 110 includes, as the processing circuits, a computing processing unit (computer) 90 such as a CPU (Central Processing Unit), storage apparatuses 91 that exchange data with the computing processing unit 90, an input circuit 92 that inputs external signals to the computing processing unit 90, an output circuit 93 that outputs signals from the computing processing unit 90 to the outside, and the like.

It may be allowed that as the computing processing unit 90, an ASIC (Application Specific Integrated Circuit), an IC (Integrated Circuit), a DSP (Digital Signal Processor), an FPGA (Field Programmable Gate Array), each of various kinds of logic circuits, each of various kinds of signal processing circuits, or the like is provided. In addition, it may be allowed that as the computing processing unit 90, two or more computing processing units of the same type or different types are provided and respective processing items are executed in a sharing manner. As the storage apparatuses 91, there are provided a RAM (Random Access Memory) that can read data from and write data in the computing processing unit 90, a ROM (Read Only Memory) that can read data from the computing processing unit 90, and the like. The input circuit 92 is connected with various kinds of sensors including the crank angle sensor 108 and the temperature sensor 109, switches, and communication lines and is provided with A/D converters, a communication circuit, and the like for inputting output signals of these sensors and switches and communication information to the computing processing unit 90. The output circuit 93 is provided with a driving circuit and the like for outputting control signals from the computing processing unit 90 to driving apparatuses including the ignition coil 104.

The computing processing unit 90 runs software items (programs) stored in the storage apparatus 91 such as a ROM and collaborates with other hardware devices in the control apparatus 110, such as the storage apparatus 91, the input circuit 92, and the output circuit 93, so that the respective functions provided in the control apparatus 110 are realized. Setting data items such as a threshold value and a determination value to be utilized in the control apparatus 110 are stored, as part of software items (programs), in the storage apparatus 91 such as a ROM. It may be allowed that the respective functions included in the control apparatus 110 are configured with either software modules or combinations of software and hardware.

It may be allowed that the ignition control unit 106 and the pressure-boosting control unit 107 are included in a control block, configured with software, in the control apparatus 110. In addition, it may be allowed that the ignition control unit 106 and the pressure-boosting control unit 107 are control circuits each of which is configured with hardware and are arranged in one and the same case in the control apparatus 110. Such arrangement also results in downsizing of the configuration and the cost reduction.

In addition, it may be allowed that the ignition control unit 106 and the pressure-boosting control unit 107 are completely independent from each other, as hardware devices. The internal combustion engine 100 may include different control apparatuses 110 each of which has a case, a power source, the input circuit 92, the output circuit 93, the computing processing unit 90, and the storage apparatus 91. Because the ignition control unit 106 and the pressure-boosting control unit 107 are made to be independent hardware devices so as to form the different control apparatuses 110, the redundancy can be raised. Even when any one of the control apparatuses 110 fails, the other control apparatus 110 can perform proxy control; thus, the failure resistance can be raised.

### <Ignition-Control Timing>

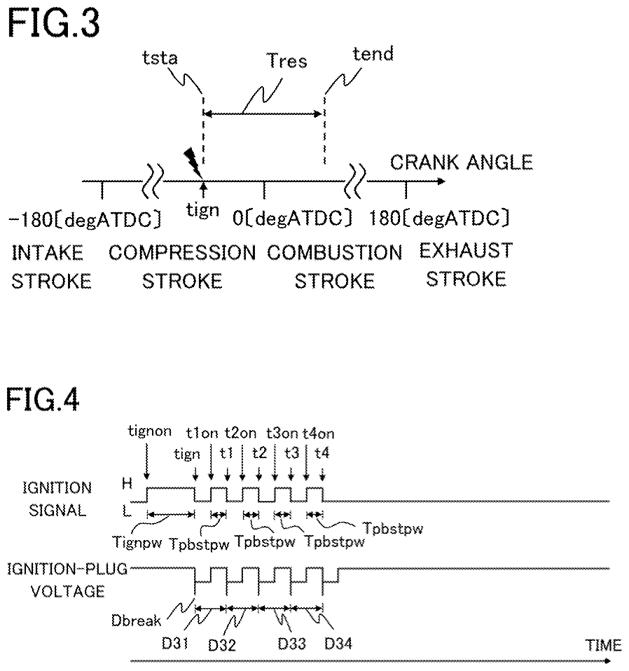

FIG. 3 is a diagram for explaining operational sections of the control apparatus according to Embodiment 1. The abscissa in FIG. 3 denotes the crank angle of the internal combustion engine 100. The crank angle of the crankshaft coupled with the rod to be driven by the piston of the internal combustion engine 100 is detected by the crank angle sensor 108. In FIG. 3, there are explained the timings at which the respective output signals of the ignition control unit 106 and the pressure-boosting control unit 107 are outputted in accordance with the crank angle. In FIG. 3, the crank angle of 0[degATDC] corresponds to the compression-stroke top dead center. A fuel-air mixture including air and fuel is taken into the main combustion chamber 105 before the intake-stroke bottom dead center, which corresponds to the crank angle of −180[degATDC]. This is an intake stroke.

In a period in which the crank angle is from substantially −180[degATDC], which corresponds to the intake-stroke bottom dead center, to substantially 0[degATDC], which corresponds to the compression-stroke top dead center, the piston sends the fuel-air mixture into the subsidiary combustion chamber 102, while compressing the fuel-air mixture inside the main combustion chamber 105. This is a compression stroke. In a normal operational section, an ignition timing tign is set before the compression-stroke top dead center, in consideration of the propagation time of a flame. At the ignition timing tign, an ignition discharge is made to occur across the discharging gap. The fuel-air mixture is ignited through the ignition discharge; then, the compression stroke is followed by a combustion stroke. After that, from around a combustion-stroke bottom dead center, which corresponds to the crank angle of 180[degATDC], burned gas starts being exhausted. This is an exhaust stroke.

The ignition control unit 106 controls the operation of the ignition coil 104, so that the ignition timing tign is controlled. Energization or de-energization of the primary coil in the ignition coil 104 is performed, so that there is controlled the timing at which an ignition discharge for ignition is made to occur across the discharging gap of the ignition plug 103 connected with the secondary coil. It may be allowed that the ignition control unit 106 is connected with various kinds of sensors including the crank angle sensor 108, switches, the ignition coil 104, actuators, and the like.

FIG. 4 is a timing chart representing the operation of the control apparatus 110 according to Embodiment 1. Hereinafter, there will be explained an operational example in which the pressure-boosting control unit 107 operates the ignition coil 104 so that a pressure rise in the subsidiary combustion chamber 102 is facilitated. The abscissa in FIG. 4 denotes the time.

The ignition control unit 106 generates an ignition signal for controlling the operation of the ignition coil 104. When the ignition signal outputted by the ignition control unit 106 is high (H), the primary coil of the ignition coil 104 is energized so that energy is accumulated in the ignition coil 104. An energization starting time point at which the ignition signal becomes high (H) is indicated by “tignon”; an energization cut-off time point (ignition timing) at which the ignition signal becomes low (L) is indicated by “tign”. An ignition-discharge energization time Tignpw is a time between the time point tignon and the time point tign.

At the timing when the ignition control unit 106 changes the state of the ignition signal from high (H) to low (L), the energization of the primary coil is cut off. At this moment, the ignition coil 104 releases the energy from the secondary coil so as to generate a high voltage. The ignition-plug voltage in FIG. 4 is a voltage generated between the electrode 103a and the grounding electrode 103b of the ignition plug 103.

The high voltage causes a dielectric breakdown across the discharging gap of the ignition plug 103, so that an ignition discharge occurs. At the ignition timing tign, an ignition discharge occurs in the subsidiary combustion chamber 102; combustion of the fuel-air mixture starts; then, the pressure in the subsidiary combustion chamber 102 starts to rise. The dielectric breakdown that occurs across the discharging gap is indicated by “Dbreak”. Due to the dielectric breakdown Dbreak, an ignition discharge starts; after the discharge continues, the discharging energy attenuates; then, the discharge ends.

It may be allowed that the logic of high (H) and low (L) of the ignition signal is reversed. In the present embodiment, in the period in which the ignition signal is high (H), the power transistor in the ignition coil 104 is turned on so as to energize the primary coil; in the period in which the ignition signal is low (L), the power transistor in the ignition coil 104 is turned off so as to de-energize the primary coil.

### <Pressure-Boosting-Control Timing>

The pressure-boosting control unit 107 facilitates a pressure rise in the subsidiary combustion chamber 102. Accordingly, the pressure-boosting control unit 107 outputs an ignition signal so that the ignition coil 104 generates a high voltage during a facilitation section Tres. Due to the high voltage generated by the ignition coil 104, a pressure-boosting discharge for boosting a pressure occurs across the discharging gap of the ignition plug 103.

In FIG. 4, there is represented an ignition signal at a time when during the facilitation section Tres represented in FIG. 3, four pressure-boosting discharges are produced after the ignition timing tign. The number of pressure-boosting discharges is not limited to four. The number of pressure-boosting discharges may be the same as or smaller than four or the same as or larger than five. In the present embodiment, the case where the number of pressure-boosting discharges is four will be explained.

The respective energization starting time points at each of which the ignition signal becomes high (H) are indicated by t1on, t2on, t1on, and t4on. The respective energization cut-off time points at each of which the ignition signal becomes low (L) are indicated by t1, t2, t3, and t4. The time period between the corresponding energization starting and energization cut-off times is indicated by a pressure-boosting-discharge energization time Tpbstpw. The respective discharge intervals are indicated by D31, D32, D33, and D34.

When the ignition signal is high (H), the primary coil of the ignition coil 104 is energized. At the timing when the state of the ignition signal is changed from high (H) to low (L), the energization of the primary coil is cut off. At this moment, the ignition coil 104 releases the energy from the secondary coil so as to generate a high voltage. A high voltage is supplied to the ignition plug 103 connected with the secondary coil. A dielectric breakdown occurs across the discharging gap, which is a space between the electrode 103a and the grounding electrode 103b of the ignition plug 103, and hence a pressure-boosting discharge is produced.

Because when a pressure-boosting discharge occurs across the discharging gap, the discharge makes a high temperature suddenly occur, a shock wave and a pressure wave are produced. As a result, it is made possible to produce a disturbance in the subsidiary combustion chamber 102 whose volume is small, for example, 1×10⁻⁶ [m³] Disturbances and motions occur in a burned gas and an unburned fuel-air mixture. Accordingly, repeated production of the pressure-boosting discharge makes it possible to produce sparse and dense combustion gases and to increase the peak pressure in the subsidiary combustion chamber 102.

Then, the injection power of the combustion flame, which is injected from the subsidiary combustion chamber 102 into the main combustion chamber 105 through the orifice 101, is reinforced. As a result, the speed and the continuity of flame propagation in the main combustion chamber 105 is raised. As a result, the combustion stability, to a lean fuel-air mixture, of the subsidiary-chamber-type internal combustion engine is improved.

It is desirable that the pressure-boosting discharge for facilitating a pressure rise in the subsidiary combustion chamber 102 is produced under the condition that an unburned fuel-air mixture exists in the subsidiary combustion chamber 102. This is because by making pressure-boosting discharge produce sparse and dense combustion gases, the combustion velocity in the subsidiary combustion chamber 102 can be raised so as to increase the pressure of the combustion gas.

The pressure-boosting control unit 107 makes a pressure-boosting discharge occur in the facilitation section Tres represented in FIG. 3. In FIG. 3, the timing tsta, which is the starting timing of the facilitation section Tres, is set to be the same as the ignition timing tign. It may be allowed that when an unburned fuel-air mixture exists in the subsidiary combustion chamber 102, the timing tsta is set to a timing after the ignition timing tign.

A timing tend, which is the timing at which the facilitation section Tres ends, may be set to a timing at which the unburned fuel-air mixture exists substantially no longer in the subsidiary combustion chamber 102. Moreover, the timing tend may be set to a timing at which the pressure in the main combustion chamber 105 reaches its peak. Furthermore, the timing tend may be a timing at which the crank angle becomes a predetermined one, for example, 20[degATDC]. Moreover, the timing tend may be a timing that is after the ignition timing tign by a predetermined crank angle, for example, after the ignition timing by a crank angle range of 30[deg]. Moreover, the timing tsta and the timing tend may be set as table values or map values that are determined, for example, by the rotation speed, the load, and the temperature of the internal combustion engine 100. This is because the pressure-boosting discharge can effectively be set in accordance with the operating state of the internal combustion engine 100.

The facilitation section Tres, the timings including the interval between pressure-boosting discharges to be produced in order to facilitate the pressure rise, and a pressure-boosting-discharge number Npbst as the number of produced pressure-boosting discharges that are controlled by the pressure-boosting control unit 107 may be tuned to one another preliminarily and experimentally. In addition, based on the result of the tuning, the foregoing items may be changed in accordance with the operational condition of the internal combustion engine 100, such as the rotation speed, the load, the temperature, and the like.

An appropriate pressure-boosting discharge can increase the pressure of a combustion gas in the subsidiary combustion chamber 102. As a result, the injection power of a combustion flame to be injected into the main combustion chamber 105 through the orifice 101 can be reinforced; thus, the speed and the continuity of flame propagation in the main combustion chamber are raised. In a subsidiary-chamber-type internal combustion engine, while keeping the diameter of an orifice having an excellent scavenging performance and a suppressed thermal loss, the combustion stability to a lean fuel-air mixture in the main combustion chamber 105 is improved. The thermal efficiency of the internal combustion engine 100 is raised and hence it is made possible to reduce the amount of the greenhouse effect gas to be exhausted.

### <Pressure-Boosting Control Corresponding to Inherent Vibration Frequency>

The timing at which a pressure-boosting discharge is produced can be set in accordance with the inherent vibration frequency of the subsidiary combustion chamber 102. This method makes it possible that a pressure wave is effectively amplified through the effect of the vibration.

Due to the effect of the vibration, the peak pressure inside the subsidiary combustion chamber 102 becomes higher. Accordingly, the pressure difference between the pressure inside the main combustion chamber 105 and the pressure inside the subsidiary combustion chamber 102 becomes larger. In addition, the injection power of a combustion flame to be injected through the orifice 101 can be reinforced; thus, the speed and the continuity of flame propagation in the main combustion chamber are raised. As a result, the combustion stability to a lean fuel-air mixture in the subsidiary-chamber-type internal combustion engine can be improved.

Here, resonance modes of combustion gas inside a cylinder will be described. Letting m and n denote the number of cylinder circumferential-direction waves and the number of cylinder radial-direction waves on a cross section perpendicular to the center axis of the cylinder, respectively, the resonance mode will be expressed with (ρ m,n).

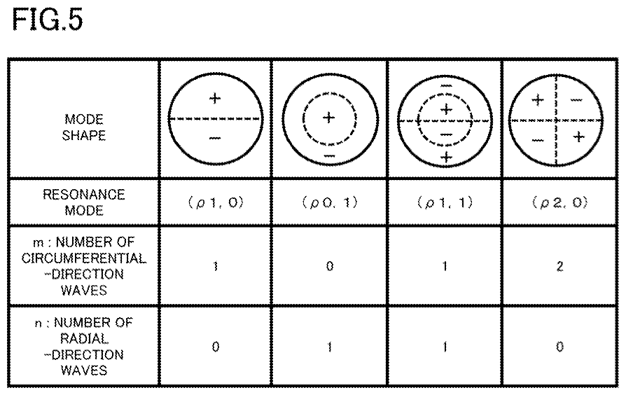

FIG. 5 is a table representing the resonance modes of combustion gas in the internal combustion engine 100 according to Embodiment 1. For example, in the case where the inside of the subsidiary combustion chamber 102 is cylindrical tubular, the inner diameter thereof is 12 [mm], and the temperature of the subsidiary combustion chamber 102 is substantially 900[° C.], the inherent vibration frequency of (ρ 1,0) mode is 34 [kHz]. In this situation, (ρ 1,0) is a resonance mode in which the circumferential-direction vibration frequency of the subsidiary combustion chamber 102 is first-order, i.e., a resonance mode at a time when the subsidiary combustion chamber 102 is divided into two portions along the diameter. This inherent vibration frequency can experimentally be obtained through actual measurement. In addition, it may be allowed that the inherent vibration frequency is calculated through the well-known Draper's equation. In the case where the vibration frequency is 34 [kHz], 1 period is 30 [μsec]. Hereinafter, this interval of 30 [μsec] calculated from the inherent vibration frequency of the subsidiary combustion chamber 102 will be referred to as a basic interval.

In FIG. 4, the ignition signal is a signal to be transmitted from the control apparatus 110 to the ignition coil 104. The ignition signal becomes high (H) at the time point tignon and changes from high (H) to low (L) at the time point tign. At the timing when the ignition signal changes from high (H) to low (L), a high voltage is generated across the secondary coil of the ignition coil 104. Then, the high voltage is supplied to the ignition plug 103.

The discharge interval between the time point tign, which is an ignition timing, and the first pressure-boosting-discharge timing t1 is D31. When the discharge interval D31 is set to the basic interval expressed by the reciprocal of the inherent vibration frequency, the pressure inside the subsidiary combustion chamber 102 can effectively be increased by means of resonance based on the pressure-boosting discharge.

The discharge interval between the first pressure-boosting discharge and the second pressure-boosting discharge is expressed by D32. Similarly, the discharge intervals after and including the third pressure-boosting discharge are expressed by D33 and D34.

It may be allowed that each of D32, D33, and D34 is set to the basic interval. In the case where a pressure-boosting discharge is repeatedly produced, the pressure inside the subsidiary combustion chamber 102 can effectively be increased by means of resonance. However, the effect of the resonance can more largely be exerted by setting each of the discharge intervals D31 through D34 including D31, which is the discharge interval between tign and t1, to the basic interval. In the case where as represented in FIG. 4, each of the discharge intervals D31, D32, D33, and D34 is set to 30 [μsec], which is the basic interval, the pressure inside the subsidiary combustion chamber 102 can effectively and rapidly be increased by means of resonance.

In the foregoing description, as an example of inherent vibration, the resonance mode of (ρ 1,0) has been explained. However, the easy-to-occur vibration mode differs depending on the shape of the inside of the subsidiary combustion chamber 102. FIG. 5 illustrates resonance modes of combustion gas.

It may be allowed that the basic interval is determined based on the resonance frequency of the resonance mode (ρ 2,0), which is a resonance mode in which the circumferential-direction vibration frequency is two-order, in accordance with the shape of the inside of the subsidiary combustion chamber 102. Moreover, it may be allowed that the basic interval is determined based on the resonance frequency of the resonance mode (ρ 0,1), which is a resonance mode in which the radial-direction vibration frequency of the subsidiary combustion chamber 102 is one-order, i.e., a resonance mode at a time when the subsidiary combustion chamber 102 is concentrically divided into two portions. Furthermore, it may be allowed that the basic interval is determined based on the resonance frequency of the resonance mode (ρ 1,1), which is a resonance mode in which the circumferential-direction vibration frequency of the subsidiary combustion chamber 102 is one-order and the radial-direction vibration frequency thereof is one-order. The effect for a pressure rise in combustion gas of the subsidiary combustion chamber 102 can be obtained through vibration, by determining the basic interval through appropriate selection of the resonance frequency.

### <Outputting Processing of Ignition Signal>

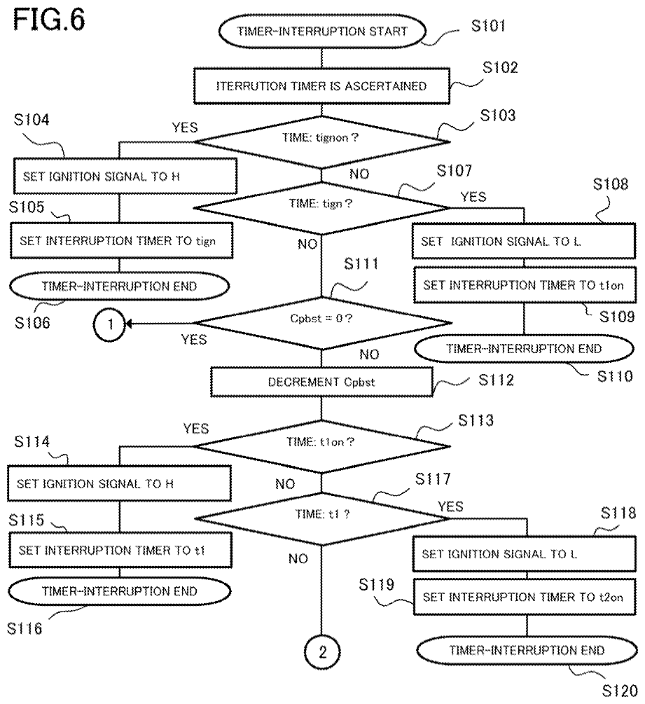

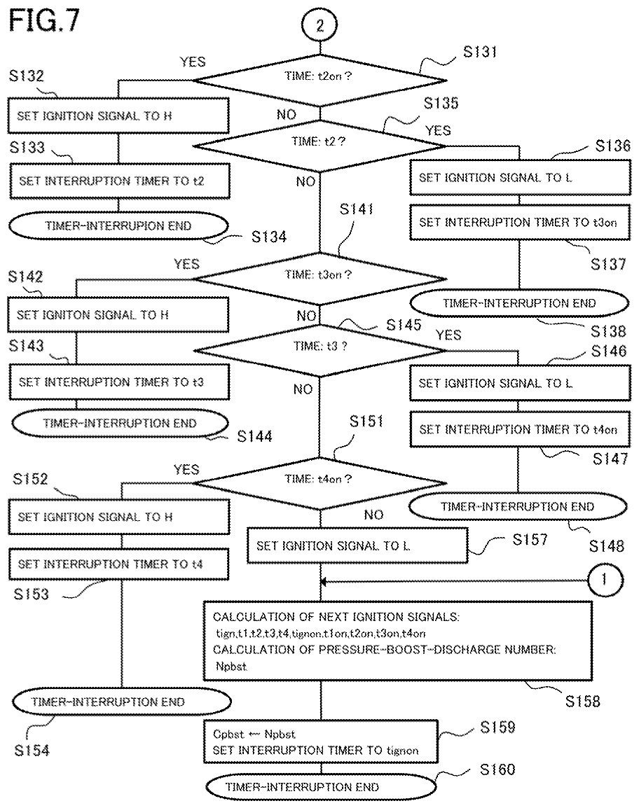

FIG. 6 is a first flowchart representing processing by the control apparatus 110 according to Embodiment 1. FIG. 7 is a second flowchart and represents the steps following FIG. 6. FIGS. 6 and 7 explain software processing of outputting the ignition signal from the control apparatus 110 for the internal combustion engine 100.

The flowcharts represented in FIGS. 6 and 7 explain the processing to be executed through timer interruption. When the present time point reaches tignon, tign, t1on, t1, t2on, t2, t3on, t3, t4on, or t4, which is a predetermined time point, corresponding each of timer interruption processing items is started.

In the present embodiment, the case where the ignition signal is turned on or off based on a time point will be explained. However, it may be allowed that the timing for turning on or off the ignition signal is specified based on not a time point but a crank angle. It may be also allowed that there is executed event-driving-type processing in which processing is executed each time the crank angle becomes each of preliminarily set angles.

Moreover, it may be also allowed that such the foregoing interruption processing is not utilized but processing is executed in a predetermined period (for example, every 10 μs). In that case, it may be allowed that it is determined whether or not switching of the ignition signal is required, by determining at every opportunity whether or not a predetermined time point or a predetermined crank angle has been reached.

In FIG. 6, timer interruption processing is started in the step S101. Then, in the step S102, an interruption timer is ascertained. That is to say, the kind of the interruption timer that has caused the interruption is ascertained. Specifically, it is ascertained to which one of tignon, tign, t1on, t1, t2on, t2, t3on, t3, t4on, or t4 the present time point coincides and hence the interruption is started.

In the step S103, it is determined whether or not the present time point is tignon. In the case where the present time point is not tignon (the determination is “NO”), the step S103 is followed by the step S107. In the case where the present time point is tignon (the determination is “YES”), the ignition signal is set to high (H) in the step S104. As a result, energization of the ignition coil 104 for an ignition discharge is started. Then, in the step S105, the interruption timer is set to the time point tign. Next, the interruption processing is ended in the step S106. Next time, the timer interruption takes place at the time point tign.

In the step S107, it is determined whether or not the present time point is tign. In the case where the present time point is not tign (the determination is “NO”), the step S107 is followed by the step S111. In the case where the present time point is tign (the determination is “YES”), the ignition signal is set to low (L) in the step S108. As a result, energization of the ignition coil 104 is cut off and hence an ignition discharge is produced. Then, in the step S109, the interruption timer is set to the time point t1on. Next, the interruption processing is ended in the step S110. Next time, the timer interruption takes place at the time point t1on.

In the step S111, it is determined whether or not the value of a pressure-boosting-discharge number counter Cpbst is 0. In the case where the value of a pressure-boosting-discharge number counter Cpbst is 0 (the determination is “YES”), the pressure-boosting discharge is ended; then, the step S111 is followed by the step S158 in FIG. 7, where the time points of the next ignition signal is calculated. In the case where the value of the pressure-boosting-discharge number counter Cpbst is not 0 (the determination is “NO”), the step S111 is followed by the step S112, where the value of the pressure-boosting-discharge number counter Cpbst is reduced (the counter is decremented by 1). The pressure-boosting discharge is executed up to the pressure-boosting number that is set, as an initial value, in the pressure-boosting-discharge number counter Cpbst.

In the step S113, it is determined whether or not the present time point is t1on. In the case where the present time point is not t1on (the determination is “NO”), the step S113 is followed by the step S117. In the case where the present time point is t1on (the determination is “YES”), the ignition signal is set to high (H) in the step S114. As a result, energization of the ignition coil 104 for a pressure-boosting discharge is started. Then, in the step S115, the interruption timer is set to the time point t1. Next, the interruption processing is ended in the step S116. Next time, the timer interruption takes place at the time point t1.

In the step S117, it is determined whether or not the present time point is t1. In the case where the present time point is not t1 (the determination is “NO”), the step S117 is followed by the step S131 in FIG. 7. In the case where the present time point is t1 (the determination is “YES”), the ignition signal is set to low (L) in the step S118. As a result, energization of the ignition coil 104 is cut off and hence a pressure-boosting discharge is produced. Then, in the step S119, the interruption timer is set to the time point t2on. Next, the interruption processing is ended in the step S120. Next time, the timer interruption takes place at the time point t2on.

In the step S131 in FIG. 7, it is determined whether or not the present time point is t2on. In the case where the present time point is not t2on (the determination is “NO”), the step S131 is followed by the step S135. In the case where the present time point is t2on (the determination is “YES”), the ignition signal is set to high (H) in the step S132. As a result, energization of the ignition coil 104 for a pressure-boosting discharge is started. Then, in the step S133, the interruption timer is set to the time point t2. Next, the interruption processing is ended in the step S134. Next time, the timer interruption takes place at the time point t2.

In the step S135, it is determined whether or not the present time point is t2. In the case where the present time point is not t2 (the determination is “NO”), the step S135 is followed by the step S141. In the case where the present time point is t2 (the determination is “YES”), the ignition signal is set to low (L) in the step S136. As a result, energization of the ignition coil 104 is cut off and hence a pressure-boosting discharge is produced. Then, in the step S137, the interruption timer is set to the time point t3on. Next, the interruption processing is ended in the step S138. Next time, the timer interruption takes place at the time point t3on.

In the step S141, it is determined whether or not the present time point is t3on. In the case where the present time point is not t3on (the determination is “NO”), the step S141 is followed by the step S145. In the case where the present time point is t3on (the determination is “YES”), the ignition signal is set to high (H) in the step S142. As a result, energization of the ignition coil 104 for a pressure-boosting discharge is started. Then, in the step S143, the interruption timer is set to the time point t3. Next, the interruption processing is ended in the step S144. Next time, the timer interruption takes place at the time point t3.

In the step S145, it is determined whether or not the present time point is t3. In the case where the present time point is not t3 (the determination is “NO”), the step S145 is followed by the step S151. In the case where the present time point is t3 (the determination is “YES”), the ignition signal is set to low (L) in the step S146. As a result, energization of the ignition coil 104 is cut off and hence a pressure-boosting discharge is produced. Then, in the step S147, the interruption timer is set to the time point t4on. Next, the interruption processing is ended in the step S148. Next time, the timer interruption takes place at the time point t4on.

In the step S151, it is determined whether or not the present time point is t4on. In the case where the present time point is not t4on (the determination is “NO”), the step S151 is followed by the step S157. In this situation, it can be determined that the present time point is not t4on.

In the case where in the step S151, the present time point is t4on (the determination is “YES”), the ignition signal is set to high (H) in the step S152. As a result, energization of the ignition coil 104 for a pressure-boosting discharge is started. Then, in the step S153, the interruption timer is set to the time point t4. Next, the interruption processing is ended in the step S154. Next time, the timer interruption takes place at the time point t4.

In the step S157, the ignition signal is set to low (L). As a result, energization of the ignition coil 104 is cut off and hence a pressure-boosting discharge is produced. Then, the step S157 is followed by the step S158.

In the step S158, the pressure-boosting discharge is ended, and the next time point for the ignition signal and the pressure-boosting-discharge number Npbst are calculated; then, the calculated data is stored in the storage apparatus. Specifically, as the respective crank angles, tignon, tign, t1on, t1, t2on, t2, t3on, t3, t4on, and t4 of the ignition signal are calculated from the next ignition timing tign, the ignition-discharge energization time Tignpw, the discharge intervals D31, D32, D33, and D34, and the pressure-boosting-discharge energization time Tpbstpw.

In accordance with the rotation speed of the crankshaft of the internal combustion engine 100, these crank angles are converted into times and then are added to the present time point. Then, the energization starting time points tignon, t1on, t2on, t3on, and t4on and the energization cut-off time points tign, t1, t2, t3, and t4 are calculated and are stored in the storage apparatus 91.

In the step S159, the initial value of the pressure-boosting-discharge number counter Cpbst is set to the pressure-boosting-discharge number Npbst. Then, the time point tignon is set to the interruption timer. Next time, the timer interruption takes place at the time point tignon. In the step S160, the interruption is ended.

In the present embodiment, the energization starting time points tignon, t1on, t2on, t1on, and t4on and the energization cut-off time points tign, t1, t2, t3, and t4 are calculated in the step S158 after the ignition signal has been changed to low (L) at the timing of the fourth pressure-boosting discharge. However, there exists a probability that the rotation speed and the load on the internal combustion engine 100 suddenly change before the next ignition signal. Accordingly, it may be allowed that the time point of the next ignition signal is calculated at a timing different from t4, after the present time point has approached the next ignition timing.

In the processing flowcharts in FIGS. 6 and 7, the steps S103 through S110 are the processing items to be executed by the ignition control unit 106, and the steps S111 through S157 are the processing items to be executed by the pressure-boosting control unit 107. In the present embodiment, there has been explained the example where the pressure-boosting-discharge number Npbst can be set to four, as the maximum value. However, even when the pressure-boosting-discharge number Npbst is increased to a value larger than four, it is made possible to configure software for executing the same processing items.

### 2. Embodiment 2

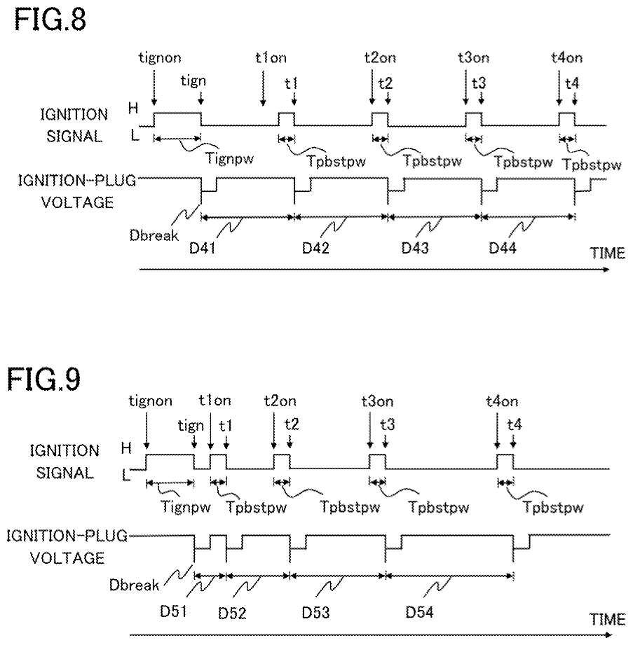

FIG. 8 is a timing chart representing the operation of a control apparatus 110 according to Embodiment 2. In Embodiment 2, the interval between pressure-boosting discharges is set to a multiplication number of the basic interval.

### <Expansion of Interval Between Pressure-Boosting Discharges>

For example, a resonance effect can be caused by setting, as represented in FIG. 8, each of the discharge intervals D41, D42, D43, and D44 to 90 [μsec], which is three times as long as the basic interval. Although the effect of amplifying the pressure wave by the resonance slightly decreases, expansion of the interval between energization and de-energization of the ignition coil 104 can suppress the ignition coil 104 and the ignition plug 103 from being excessively heated.

This is because the expansion of the interval between the pressure-boosting discharges makes it possible to secure the heat radiation periods for the ignition coil 104 and the ignition plug 103. As a result, the reliabilities of the ignition coil 104 and the ignition plug 103 can be raised, and the lifetimes thereof can be prolonged. In addition, the multiplication number for the basic interval is not limited to 3.

The flowcharts represented in FIGS. 6 and 7 can be applied to the processing in the control apparatus 110 according to Embodiment 2. When the energization starting time points tignon, t1on, t2on, t1on, and t4on and the energization cut-off time points tign, t1, t2, t3, and t4 are calculated in the step S158, not the discharge intervals D31, D32, D33, and D34 but the discharge intervals D41, D42, D43, and D44 are utilized, so that the respective time points of the ignition signal can appropriately be set.

With regard to the discharge interval for producing a pressure-boosting discharge, it may be allowed that based on the operational condition of the internal combustion engine 100, an appropriate multiplication number for the basic interval is selected so as to produce a pressure-boosting discharge. In other words, it may be allowed that the timings at each of which a pressure-boosting discharge is produced in the facilitation section Tres and the number of times of pressure-boosting discharges are preliminarily determined, through a tuning evaluation test or the like, in accordance with the operational condition of the internal combustion engine 100 and are stored, as the table values and map values of the condition for pressure-boosting discharge.

### 3. Embodiment 3

FIG. 9 is a timing chart representing the operation of a control apparatus 110 according to Embodiment 3. In Embodiment 3, the interval between the pressure-boosting discharges is not uniform but is varied.

### <Change in Interval Between Pressure-Boosting Discharges>

As represented in FIG. 9, the discharge interval D51 between tign and the first pressure-boosting-discharge timing t1 is set to 30 [μsec], which is the basic interval. Then, the discharge interval D52 between the first pressure-boosting discharge and the second pressure-boosting discharge is set to 60 [μsec], which is twice as long as the basic interval. Then, the discharge interval D53 between the second pressure-boosting discharge and the third pressure-boosting discharge is set to 90 [μsec], which is three times as long as the basic interval. Then, the discharge interval D54 between the third pressure-boosting discharge and the fourth pressure-boosting discharge is set to 150 [μsec], which is five times as long as the basic interval.

When as described above, a pressure-boosting discharge is executed firstly in a short interval and then a pressure-boosting discharge is executed in a long interval, an advantageous effect is produced. At the first stage, a resonance effect produced by a short-interval pressure-boosting discharge makes it possible to rapidly amplify a pressure wave. Moreover, at the latter stage where the effect of heat generation caused by a discharge is accumulated, a longer discharge interval is adopted, so that the pressure inside the subsidiary combustion chamber 102 can effectively be increased while the thermal loads on the ignition coil 104 and the ignition plug are reduced. Rapid pressure boosting and enhancement of the reliabilities of the ignition coil 104 and the ignition plug 103, i.e., prolongation of the lifetime, can coexist with each other. It is not required to limit the change in the discharge interval to the example represented in FIG. 9. It may be allowed that when the number of pressure-boosting discharges has exceeded a predetermined number, the discharge interval is prolonged. Moreover, the degree of the change in the discharge interval may be varied in accordance with the operating state of the internal combustion engine 100.

The flowcharts represented in FIGS. 6 and 7 can be applied to the processing in the control apparatus 110 according to Embodiment 3. When the energization starting time points tignon, t1on, t2on, t1on, and t4on and the energization cut-off time points tign, t1, t2, t3, and t4 are calculated in the step S158, not the discharge intervals D31, D32, D33, and D34 but the discharge intervals D51, D52, D53, and D54 are utilized, so that the respective time points of the ignition signal can appropriately be set.

### 4. Embodiment 4

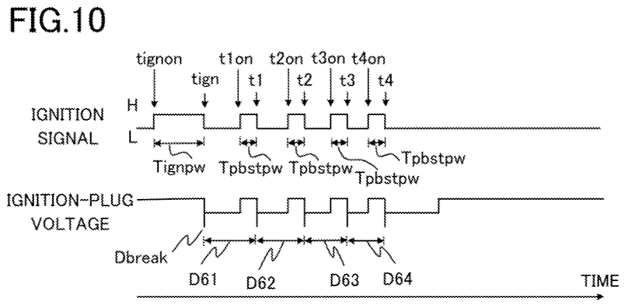

FIG. 10 is a timing chart representing the operation of a control apparatus 110 according to Embodiment 4. In Embodiment 4, the interval between pressure-boosting discharges is changed in accordance with the operating state of the internal combustion engine 100.

### <Pressure-Boosting Control Corresponding to Temperature of Internal Combustion Engine>

The inherent vibration frequency inside the subsidiary combustion chamber 102 depends on the temperature inside the subsidiary combustion chamber 102. Accordingly, when the basic interval is changed in accordance with the temperature situation inside the subsidiary combustion chamber, the pressure inside the subsidiary combustion chamber 102 can more efficiently be increased.

When the amount of the fuel-air mixture in the subsidiary combustion chamber 102 increases, for example, under the operational condition that the load is large (e.g., the throttle opening degree is large), the temperature inside the subsidiary combustion chamber 102 becomes extremely high. In addition, for example, in the case where because the rotation speed of the internal combustion engine 100 is high, the amount of heat inputted per unit time to the subsidiary combustion chamber 102 is large and hence cooling cannot sufficiently be performed, the temperature inside the subsidiary combustion chamber 102 becomes extremely high.

Under such a condition, for example, the temperature inside the subsidiary combustion chamber 102 may become substantially 1800° C. In that case, when as described above, the inner diameter of the subsidiary combustion chamber 102 is 12 [mm], the inherent vibration frequency of the resonance mode (ρ 1,0) and the basic interval become 45 [kHz] and 22 [μsec], respectively.

When the amount of the fuel-air mixture in the subsidiary combustion chamber 102 decreases, for example, under the operational condition that the load is small (e.g., the throttle opening degree is small), the temperature inside the subsidiary combustion chamber 102 becomes relatively low. Moreover, when the rotation speed of the internal combustion engine 100 is low, the temperature inside the subsidiary combustion chamber 102 becomes relatively low. This is because there is prolonged the cooling period in which the combustion gas inside the subsidiary combustion chamber 102 is cooled due to heat transfer thereof to the wall surface of the subsidiary combustion chamber 102.

Accordingly, it is desirable that in the operating state that the load is large or that the rotation speed of the internal combustion engine 100 is high, the basic interval is set to a short one so as to coincide with a change in the fundamental frequency of the subsidiary combustion chamber 102. In addition, it is desirable that under the operational condition that the load is small or that the rotation speed of the internal combustion engine 100 is low, the basic interval is set to a long one.

It may be allowed that because even during one and the same facilitation section Tres, the temperature inside the subsidiary combustion chamber 102 changes from moment to moment, fine adjustment of the basic interval is made capable of being made appropriately. For example, combustion occurs after the ignition timing tign and hence the temperature inside the subsidiary combustion chamber 102 suddenly rises. As represented in FIG. 10, the discharge intervals D61, D62, D63, and D64 are set to 30 [μsec], 29 [μsec], 28 [μsec], and 27 [μsec], respectively. The fine adjustment is made in a direction in which the basic interval is shortened in steps of 1 [μsec] every pressure-boosting discharge. By adjusting the basic interval with time in such a manner as described above, a change in the fundamental frequency due to a change in the temperature can be dealt with. As a result, the pressure rise in the subsidiary combustion chamber 102 can be facilitated.

Moreover, it may be allowed that when the temperature inside the subsidiary combustion chamber 102 can be measured by the temperature sensor 109 or the like, the basic interval is adjusted in accordance with the measured temperature. Moreover, it may be allowed that the basic interval is adjusted in accordance with the changing rate of the temperature inside the subsidiary combustion chamber 102 or the prediction value of the temperature inside the subsidiary combustion chamber 102. The measurement and the prediction of the temperature inside the subsidiary combustion chamber 102 may be performed based on the coolant temperature of the internal combustion engine 100 or based on the intake air temperature, the time elapsed after the operation start, the detection value of a temperature sensor mounted directly to the main combustion chamber, or the like.

The flowcharts represented in FIGS. 6 and 7 can be applied to the processing in the control apparatus 110 according to Embodiment 4. When the energization starting time points tignon, t1on, t2on, t1on, and t4on and the energization cut-off time points tign, t1, t2, t3, and t4 are calculated in the step S158, not the discharge intervals D31, D32, D33, and D34 but the discharge intervals D61, D62, D63, and D64 are utilized, so that the respective time points of the ignition signal can appropriately be set. In addition, it may be allowed that these time points are calculated in accordance with the rotation speed or the load on the internal combustion engine 100 or the temperature inside the subsidiary combustion chamber 102.

### <Pressure-Boosting Control Corresponding to Load on Internal Combustion Engine>

For example, under a high-load operational condition that the intake air pressure exceeds 70 [kPa], the fuel-air mixture in the main combustion chamber 105 is set to be relatively rich and hence the flammability is high. Accordingly, because under a high-load operational condition, it is not required to produce a pressure-boosting discharge, the pressure-boosting-discharge number Npbst can be set to 0. No unrequired pressure-boosting discharge is executed, so that consumption of electric energy can be suppressed. Accordingly, this method contributes to gasoline-mileage reduction and hence can contribute also to reduction of greenhouse effect gas. Moreover, the suppression of unnecessary pressure-boosting discharge makes it possible to suppress the wear and tear of the electrode 103a and the grounding electrode 103b of the ignition plug 103; thus, this method can realize enhancement of the reliability and prolongation of the lifetime.

In addition, under a low-load operational condition that the intake air pressure is lower than 30 [kPa], the fuel-air mixture in the main combustion chamber 105 is set to be lean or super lean and hence the combustion is liable to become unstable. Accordingly, in order to raise the flammability of the fuel-air mixture in the main combustion chamber 105, Npbst is set in such a way that the pressure-boosting discharge occurs, for example, ten times. As a result, the lean fuel-air mixture at a time of a low load can stably be combusted.

As the load on the internal combustion engine 100 becomes higher, the flammability is improved. Accordingly, it is made possible to set the pressure-boosting-discharge number Npbst smaller, as the load becomes higher. This method makes it possible to set the pressure-boosting-discharge number Npbst to an optimum one in response to a change in the operational condition of the internal combustion engine 100. It can be achieved that the stability of the combustion of the fuel-air mixture in the main combustion chamber 105 is secured, that the gasoline-mileage is reduced by preventing unnecessary pressure-boosting discharge from occurring, and that the wear and tear of the electrode 103a and the grounding electrode 103b of the ignition plug 103 is suppressed.

The timing at which a pressure-boosting discharge is produced and the pressure-boosting-discharge number Npbst may appropriately be determined in the facilitation section Tres. It may be allowed that based on the table value and the map value set through tuning or the like in accordance with the operating state of the internal combustion engine 100, the optimum timing and pressure-boosting-discharge number Npbst are determined.

In the flowcharts in FIGS. 6 and 7, at the time when the energization starting time points tignon, t1on, t2on, t1on, and t4on and the energization cut-off time points tign, t1, t2, t3, and t4 are calculated in the step S158, the discharge interval and the pressure-boosting-discharge number Npbst can be determined in accordance with the rotation speed, the load, or the temperature of the internal combustion engine 100. Moreover, it may be allowed that each of the ignition-discharge energization time Tignpw and the pressure-boosting-discharge energization time Tpbstpw is also determined based on the table value and the map value set in accordance with the operating state of the internal combustion engine 100. This is because energy necessary for each of ignition discharge and pressure-boosting discharge can appropriately be secured.

It is significant that each of the discharge interval, the energization duration, the pressure-boosting-discharge number Npbst, and the like are preliminarily set, as a table value and a map value determined from the rotation speed, the load, and the temperature of the internal combustion engine 100 and the like. That is because there can concurrently be achieved all of the issues, i.e., that the stability of the combustion of the fuel-air mixture in the main combustion chamber 105 is secured, that the gasoline-mileage is reduced by preventing unnecessary pressure-boosting discharge from occurring, and that the wear and tear of the electrode 103a and the grounding electrode 103b of the ignition plug 103 is suppressed.

Although the present application is described above in terms of various exemplary embodiments and implementations, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the present disclosure. For example, there are included the case where at least one constituent element is modified, added, or omitted and the case where at least one constituent element is extracted and then combined with constituent elements of other embodiments.

### DESCRIPTION OF REFERENCE NUMERALS

100: internal combustion engine
101: orifice
102: subsidiary combustion chamber
103: ignition plug
103a: electrode
103b: grounding electrode
104: ignition coil
105: main combustion chamber
106: ignition control unit
107: pressure-boosting control unit
108: crank angle sensor
109: temperature sensor
110: control apparatus
Cpbst: pressure-boosting-discharge number counter
D31, D32, D33, D34, D41, D42, D43, D44, D51, D52, D53, D54, D61, D62, D63, and D64: discharge interval
Npbst: pressure-boosting-discharge number

What is claimed is:

1. An internal-combustion-engine control apparatus for controlling an internal combustion engine having
a main combustion chamber,
a subsidiary combustion chamber,
an ignition plug that is disposed in the subsidiary combustion chamber,
an ignition coil connected with the ignition plug, and
an orifice for connecting the subsidiary combustion chamber with the main combustion chamber and for injecting combustion gas in the subsidiary combustion chamber into the main combustion chamber so as to ignite a fuel-air mixture in the main combustion chamber, the internal-combustion-engine control apparatus comprising:
an ignition controller that controls energization of the ignition coil so that an ignition discharge for igniting a fuel-air mixture in the subsidiary combustion chamber is produced across the ignition plug; and
a pressure-boosting controller that controls energization of the ignition coil so that a pressure-boosting discharge for increasing a pressure of combustion gas in the subsidiary combustion chamber is produced across the ignition plug.

2. The internal-combustion-engine control apparatus according to claim 1, wherein the pressure-boosting controller controls energization of the ignition coil so as to produce the pressure-boosting discharge at a time when a period determined based on an inherent vibration frequency of the subsidiary combustion chamber elapses after the ignition discharge has been produced by the ignition coil, energization of which is controlled by the ignition controller.

3. The internal-combustion-engine control apparatus according to claim 1, wherein the pressure-boosting controller produces the pressure-boosting discharge two or more times by controlling energization of the ignition coil at intervals determined based on the inherent vibration frequency of the subsidiary combustion chamber.

4. The internal-combustion-engine control apparatus according to claim 3, wherein the pressure-boosting controller produces the pressure-boosting discharge two or more times by controlling energization of the ignition coil at intervals of integral multiples of a reciprocal of the inherent vibration frequency of the subsidiary combustion chamber.

5. The internal-combustion-engine control apparatus according to claim 3, wherein the pressure-boosting controller has a counter for counting the number of times of the pressure-boosting discharges and controls energization of the ignition coil so as to prolong an interval between the pressure-boosting discharges, when a count value of the counter is larger than a predetermined number of times.

6. The internal-combustion-engine control apparatus according to claim 1, wherein the pressure-boosting controller controls energization of the ignition coil so as to produce the pressure-boosting discharge within a period in which a fuel-air mixture exists in the subsidiary combustion chamber, after the ignition discharge has been produced by the ignition coil, energization of which is controlled by the ignition controller.

7. The internal-combustion-engine control apparatus according to claim 1, wherein the pressure-boosting controller controls energization of the ignition coil so as to produce the pressure-boosting discharge within a period before a pressure in the main combustion chamber becomes maximum, after the ignition discharge has been produced by the ignition coil, energization of which is controlled by the ignition controller.

8. The internal-combustion-engine control apparatus according to claim 1, wherein the pressure-boosting controller controls energization of the ignition coil so as to produce the pressure-boosting discharge within a period determined in accordance with an operating state of an internal combustion engine, after the ignition discharge has been produced by the ignition coil, energization of which is controlled by the ignition controller.

9. The internal-combustion-engine control apparatus according to claim 1, wherein the pressure-boosting controller controls energization of the ignition coil so as to produce the pressure-boosting discharge at intervals determined in accordance with an operating state of an internal combustion engine, after the ignition discharge has been produced by the ignition coil, energization of which is controlled by the ignition controller.

10. The internal-combustion-engine control apparatus according to claim 1, wherein the pressure-boosting controller controls energization of the ignition coil so as to produce the pressure-boosting discharge at intervals determined in accordance with a temperature of the subsidiary combustion chamber, after the ignition discharge has been produced by the ignition coil, energization of which is controlled by the ignition controller.

11. The internal-combustion-engine control apparatus according to claim 1, wherein the pressure-boosting controller controls energization of the ignition coil so as to produce the pressure-boosting discharge a number of times determined in accordance with an operating state of an internal combustion engine, after the ignition discharge has been produced by the ignition coil, energization of which is controlled by the ignition controller.

12. The internal-combustion-engine control apparatus according to claim 1, wherein the ignition controller and the pressure-boosting controller are arranged in one and the same case.
